(19) United States
(12) Patent Application Publication
(10) Pub. No.: US 2015/0207167 A1
(43) Pub. Date: Jul. 23, 2015

(54) THIN BATTERY AND PRODUCTION METHOD THEREOF

(71) Applicant: Panasonic Intellectual Property Management Co., Ltd., Osaka (JP)

(72) Inventors: Tomohiro Ueda, Osaka (JP); Yuya Asano, Osaka (JP); Toshifumi Nagino, Osaka (JP)

(21) Appl. No.: 14/421,129

(22) PCT Filed: Sep. 20, 2013
(86) PCT No.: PCT/JP2013/005545

§ 371 Date: Feb. 11, 2015

(30) Foreign Application Priority Data
Sep. 24, 2012 (JP) 2012-209935

(51) Int. Cl. H01M 10/02; H01M 2/02

(52) U.S. Cl. CPC H01M 10/02; H01M 2/0275; H01M 2220/30

(57) ABSTRACT

Provided is a thin battery including: an electrode assembly; and a flexible housing configured to house the electrode assembly. The electrode assembly includes: a positive electrode in sheet form; a negative electrode in sheet form; and an electrolyte layer interposed therebetween. The electrolyte layer includes: a non-aqueous electrolyte; and a non-woven fabric sheet configured to retain the non-aqueous electrolyte. The non-woven fabric sheet includes a conjugated fiber including at least two kinds of macromolecules conjugated together. The at least two kinds of macromolecules include: a first macromolecule without a cross-linked structure; and a second macromolecule with a cross-linked structure.

### TECHNICAL FIELD

The present invention relates to a thin battery including an electrode assembly and a flexible housing configured to house the same, the electrode assembly including a positive electrode in sheet form, a negative electrode in sheet form, and an electrolyte layer interposed therebetween.

### BACKGROUND ART

In recent years, portable electronic devices with compact design such as mobile phones and hearing aids have been making progress. Moreover, devices that operate in contact with a living body have been increasing. For example, a biological information signal generating device capable of measuring and monitoring biological information such as body temperature, blood pressure, and pulse, and automatically sending such biological information to facilities such as hospitals, has been developed. Moreover, a biological wearable device capable of supplying medicine or other substances through the outer skin of a living body by voltage application, has also been developed.

Under such circumstances, batteries for supplying power are required to be thinner and more flexible. For thin batteries, paper batteries, flat batteries, and plate batteries have already been developed. However, although such thin batteries have excellent strength, they cannot be easily made thinner or more flexible, which serves to be a problem.

On the other hand, a technique using a thin flexible laminate sheet for the housing for the batteries has been developed (c.f., Patent Literatures 1 and 2). Such batteries include an electrode assembly having a laminated structure of a positive electrode and a negative electrode, both in flat plate form, with a separator interposed therebetween. In this structure, a positive electrode lead and a negative electrode lead are connected to the positive electrode and the negative electrode, respectively; and partially extend from the housing to the outside. The exposed portions of the positive and negative electrode leads serve as the positive and negative terminals, respectively. However, even if the housing is flexible, if the electrode assembly is not sufficiently flexible, battery performance would degrade considerably with repeated bending of the batteries.

Therefore, thinning of battery components such as electrodes that form the electrode assembly has also been studied. For example, formation of an active material layer by a gas-phase process has been studied (c.f., Patent Literature 3). However, in a gas-phase process, it is not easy to form an active material having sufficient thickness, and it is therefore extremely difficult to produce a thin battery having high capacity. That is, there is a limit to improving flexibility of the electrode assembly via thinning of the battery components.

### PRIOR ART

### Patent Literature

[Patent Literature 1] Japanese Laid-Open Patent Publication No. Hei 11-345599

[Patent Literature 2] Japanese Laid-Open Patent Publication No. 2008-71732

[Patent Literature 3] Japanese Laid-Open Patent Publication No. 2009-9897

### SUMMARY OF INVENTION

### Technical Problem

The present inventors found that degradation of battery performance with repeated bending of the battery was caused by decrease in the contact area between the active material and the electrolyte layer (i.e., separation from each other) at the interface (hereafter referred to as electrode interface) between the positive or negative electrode and the electrolyte layer.

As above, damage to the electrode assembly with repeated bending of the battery is mostly caused due to separation of the electrode and the electrolyte layer. For example, a device that operates in contact with a living body is bent repeatedly with movements made by the living body. At that time, lesser flexibility of the electrode assembly causes greater stress to the electrode assembly due to bending; and such greater stress facilitates the separation. When the electrode and the electrolyte layer separate, battery performance degrades considerably.

In view of the foregoing, if adhesion between the electrode and the electrolyte layer can be improved and separation of the two can be suppressed, performance degradation due to bending of the battery may be suppressed. Therefore, an object of the present invention is to provide a thin battery having excellent resistance to degradation due to bending, by suppressing separation of the electrode and the electrolyte layer.

### Solution to Problem

One aspect of the present invention relates to a thin battery including:

an electrode assembly; and

a flexible housing configured to house the electrode assembly,

the electrode assembly including:

a positive electrode in sheet form;

a negative electrode in sheet form; and

an electrolyte layer interposed between the positive electrode and the negative electrode,

the electrolyte layer including:

a non-aqueous electrolyte; and

a non-woven fabric sheet configured to retain the non-aqueous electrolyte,

the non-woven fabric sheet including a conjugated fiber including at least two kinds of macromolecules conjugated together, and

the at least two kinds of macromolecules including:

a first macromolecule without a cross-linked structure; and

a second macromolecule with a cross-linked structure.

Another aspect of the present invention relates to a production method of a thin battery, the method including:

(i) preparing a positive electrode in sheet form;

(ii) preparing a negative electrode in sheet form;

(iii) producing a conjugated fiber including a first macromolecule without a cross-linked structure and a second macromolecule with a cross-linked structure by electrospinning, from a starting solution including at least the first macromolecule and the second macromolecule;

(iv) forming a non-woven fabric sheet including the conjugated fiber, by depositing the produced conjugated fiber on a surface of at least one of the positive electrode and the negative electrode;

(v) forming an electrode assembly by lamination of the positive electrode and the negative electrode, with the non-woven fabric sheet interposed therebetween; and

(vi) housing the electrode assembly and a non-aqueous electrolyte in a flexible housing and then hermetically sealing the housing under reduced pressure.

### Advantageous Effect of Invention

According to the present invention, there can be obtained a thin battery having excellent resistance to degradation due to bending, unlikely to degrade in performance even with repeated bending. Thus, long-term use of a device requiring flexibility is possible, even with the thin battery loaded therein.

### BRIEF DESCRIPTION OF DRAWINGS

FIG. 1 is a sectional view of a thin battery according to an embodiment of the present invention.

FIG. 2 is a top view of the thin battery.

FIG. 3 is a sectional view of a laminate sheet for use as the housing.

FIG. 4 is an oblique view of an example of a device with the thin battery loaded therein.

FIG. 5 is an illustration of an example of the appearance of the device when deformed.

FIG. 6 is a schematic illustration of the configuration of an example of a system for producing a non-woven fabric sheet according to the present invention.

FIG. 7 is a conceptual top view of the configuration of a relevant part (discharger) of an electrospinning mechanism provided in the system.

FIG. 8 is a graph showing discharge curves before and after conducting a bending deformation treatment on a thin battery according to Example 1.

FIG. 9A is a sectional image of a conjugated fiber forming a non-woven fabric sheet according to Example 1.

FIG. 9B is a sectional image of the non-woven fabric sheet according to Example 1.

FIG. 10 is a graph showing discharge curves before and after conducting a bending deformation treatment on a thin battery according to Comparative Example 1.

FIG. 11 is a graph showing discharge curves before and after conducting a bending deformation treatment on a thin battery according to Comparative Example 2.

### DESCRIPTION OF EMBODIMENTS

A thin battery of the present invention includes: an electrode assembly; and a flexible housing configured to house the electrode assembly. The housing is, for example, formed in the shape of a pouch from a flexible sheet. The electrode assembly includes: a positive electrode in sheet form; a negative electrode in sheet form; and an electrolyte layer interposed between the positive electrode and the negative electrode. The electrolyte layer includes: a non-aqueous electrolyte; and a non-woven fabric sheet configured to retain the non-aqueous electrolyte. The non-woven fabric sheet may be swollen with the non-aqueous electrolyte.

The non-woven fabric sheet includes a conjugated fiber including at least two kinds of macromolecules that are conjugated. Here, conjugated fiber does not mean a composite material including a first fiber formed of a single macromolecule and a second fiber formed of another single macromolecule; but means a filament formed of two or more kinds of macromolecules. The conjugated fiber is, for example, formed from a polymer alloy including at least two kinds of macromolecules. Thus, when observed in detail, a section of a filament of the conjugated fiber shows at least two phases of different macromolecules.

The at least two kinds of macromolecules include: a first macromolecule without a cross-linked structure; and a second macromolecule with a cross-linked structure. The first macromolecule without a cross-linked structure included in the conjugated fiber allows formation of a non-woven fabric sheet with a fiber of good quality. On the other hand, the second macromolecule with a cross-linked structure included in the conjugated fiber allows formation of a non-woven fabric sheet with excellent adhesion to the positive and negative electrodes, retention of the non-aqueous electrolyte, and strength. Note that the conjugated fiber may include three or more kinds of macromolecules.

The electrolyte layer including the non-woven fabric sheet as above has excellent adhesion to the electrodes. Therefore, regardless of the flexibility of the electrode assembly, even with repeated bending of the battery, decrease in the contact area between the active materials and the electrolyte layer at the electrode interfaces, i.e., separation of the active materials and the electrolyte layer, is unlikely to occur.

The section of the conjugated fiber preferably has a matrix-domain structure (sea and island structure) including: a matrix element (sea); and a domain element (island) dispersed in the matrix element. In that case, the second macromolecule with a cross-linked structure tends to form the matrix element, whereas the first macromolecule without a cross-linked structure tends to form the domain element.

Since the conjugated fiber having the matrix-domain structure is homogeneous, a non-woven fabric sheet can be formed of the fiber of better quality (e.g., homogeneous nanofibers with a fiber diameter of 800 nm or less). Moreover, since the second macromolecule with excellent adhesion to the electrodes, retention of the non-aqueous electrolyte, and strength spreads in the electrolyte layer in a mesh-like manner, adhesion between the electrodes and the electrolyte layer as well as retention of the non-aqueous electrolyte also become homogeneous.

The content of the first macromolecule in the conjugated fiber is preferably 10 to 70 mass % and further preferably 30 to 50 mass %. The first macromolecule in such proportion allows easier conversion of the conjugated material into fiber form. Thus, it becomes easier to obtain homogeneous nanofibers with a fiber diameter of 800 nm or less.

The conjugated fiber may include three or more kinds of macromolecules. However, in view of securing good adhesion between the electrodes and the electrolyte layer as well as sufficient retention of the non-aqueous electrolyte by the non-woven fabric sheet, the total of the first and second macromolecules is preferably 50 mass % or more and further preferably 80 mass % or more of the conjugated fiber.

The first macromolecule is not particularly limited as long as it does not have a cross-linked structure, and examples include olefin resins, fluorocarbon resins, polyamide resins, and polyimide resins. Such macromolecules are favorable because they can increase affinity for the non-aqueous electrolyte. Among these, fluorocarbon resins are preferred as the first macromolecule, due to facilitating conversion of the conjugated material into fiber form and having chemical stability.

Examples of fluorocarbon resins include homopolymers or copolymers having fluorine-containing monomer units, such as: polytetrafluoroethylene (PTFE), tetrafluoroethylene-hexafluoropropylene copolymer (FEP), vinylidene fluoride-hexafluoropropylene copolymer, tetrafluoroethylene-perfluoroalkyl vinyl ether copolymer (PFA), tetrafluoroethylene-ethylene copolymer, polyvinylidene fluoride (PVDF), and polyvinyl fluoride (PVF).

Among fluorocarbon resins, a polymer having vinylidene fluoride units is preferred due to having high affinity for the non-aqueous electrolyte. In such polymer, the proportion of the vinylidene fluoride units is preferably 50 to 100 mol % and further preferably 65 to 95 mol % for example.

The polymer having vinylidene fluoride units is preferably a copolymer including vinylidene fluoride units and hexafluoropropylene units for example. In such copolymer, the proportion of the hexafluoropropylene units is preferably 0 to 50 mol % and further preferably 5 to 35 mol %. Use of such polymer results in obtaining a non-woven fabric sheet having excellent strength in addition to having better affinity for the non-aqueous electrolyte.

The weight-average molecular weight of the first macromolecule is not particularly limited, and is preferably 100,000 to 2,000,000 and further preferably 150,000 to 1,000,000, in view of conversion into fiber form by electrospinning. This is because the first macromolecule with such molecular weight easily dissolves in a solvent and facilitates concentration adjustment for a solution.

The second macromolecule is not particularly limited as long as it has a cross-linked structure. For example, polymers including monomer units such as acrylic acid, methacrylic acid, acrylic ester, methacrylic ester, vinyl acetate, acrylonitrile, styrene, divinylbenzene, and alkylene oxide are preferable. These monomer units may be used singly or in a combination of two or more. The ester group in acrylic ester and methacrylic ester preferably has a C2 to C10 (preferably C2 to C8) alkyl group or polyalkylene oxide group for example, in view of improving adhesion.

Specific examples of the second macromolecule include polyvinyl acetate, ethylene-vinyl acetate copolymer, polyvinyl alcohol, polyalkylene oxide, modified polystyrene, polyacrylonitrile, poly(alkyl acrylate), poly(alkyl methacrylate), polyester, and copolymers thereof. Preferred among the above are: a polymer (acrylic resin) including at least one kind (hereafter referred to as (meth)acrylic ester) selected from the group consisting of acrylic ester units and methacrylic ester units; and a macromolecule having a polyalkylene oxide structure, due to their high adhesion and high affinity for the electrode active materials.

In the macromolecule having a polyalkylene oxide structure, the content of the polyalkylene oxide structure is preferably controlled to 20 to 95 mass %. This is because the macromolecule including the polyalkylene structure in such proportion not only has excellent adhesion, but also is capable of relatively easily converting into fiber form by being conjugated with the first macromolecule.

The weight-average molecular weight of the second macromolecule is not particularly limited, and is preferably 300,000 to 6,000,000 and further preferably 500,000 to 5,000,000, in view of conversion into fiber form by electrospinning. Use of the second polymer with such molecular weight facilitates formation of a conjugated fiber with excellent strength.

The second macromolecule may be a polymer (e.g., dendrimer) having a core-shell structure with a core part and a shell part. Shell parts of such polymers adjacent to one another are linked to form a cross-linked structure, thereby to become the matrix element in the matrix-domain structure. Such matrix element has excellent adhesion, retention of the non-aqueous electrolyte, and strength. Thus, it becomes easier to obtain a thin battery unlikely to degrade in performance even with repeated severe bending.

The shell part preferably has a structure with excellent viscosity, in view of achieving sufficient adhesion. Such structure preferably has a segment formed of, for example, a polymer including at least one of acrylic ester and methacrylic ester; and such ester part has a flexible molecular chain of, for example, a polyene structure, a polyalkylene oxide structure, or a C2 to C10 (preferably C2 to C8) alkyl group.

The core part preferably has a structure with excellent elasticity, in view of imparting strength to the matrix element. Such structure has a segment formed of, for example, a polymer including styrene or acrylonitirile. More specifically, a polystyrene structure, a styrene-butadiene copolymer structure, a styrene-acrylonitrile copolymer structure, or the like is preferable.

Among polymers having a core-shell structure, a macromolecule having a shell part with a polyalkylene oxide structure (polyethylene oxide group, in particular) has high viscosity and affinity for the electrode active materials, and is therefore favorable in improving adhesion between the electrode and the electrolyte layer.

On the other hand, the core part preferably has a polystyrene structure. Such polystyrene structure allows the core part to have good elasticity and facilitates formation of a conjugated fiber with excellent strength.

One method for producing cross links in a polymer having a core-shell structure, is to introduce in advance a hydroxl group, an acyl group, or the like to side chains or ends in the shell part; and later add a cross-linking agent to the resultant. For example, in the instance where a hydroxyl group is introduced into the shell part of a polymer having a core-shell structure, a cross-linking agent having two or more functional groups (e.g., isocyanate groups) that are reactive with a hydroxyl group is made to react with the polymer having a core-shell structure, and a cross-linked structure is formed as a result.

The non-woven fabric sheet is preferably formed directly on a surface of at least one of the positive electrode and the negative electrode by electrospinning. More specifically, the non-woven fabric sheet is preferably formed by producing the conjugated fiber from a starting solution including the first macromolecule and the second macromolecule by electrostatic force; and depositing the produced conjugated fiber on the electrode surface. The non-woven fabric sheet formed by direct deposition of the conjugated fiber on the electrode surface partially becomes conjugated with the electrode surface or the like, and thereby very firmly adheres to the electrode surface. The conjugated fiber may be formed on the positive electrode surface, the negative electrode surface, or both the positive electrode surface and the negative electrode surface.

That is, the thin battery is preferably produced by a production method including, for example:

(i) preparing a positive electrode in sheet form;

(ii) preparing a negative electrode in sheet form;

(iii) producing a conjugated fiber including a first macromolecule without a cross-linked structure and a second macromolecule with a cross-linked structure by electrospinning, from a starting solution including at least the first macromolecule and the second macromolecule;

(iv) forming a non-woven fabric sheet including the conjugated fiber, by depositing the produced conjugated fiber on a surface of the electrode;

(v) forming an electrode assembly by lamination of the positive electrode and the negative electrode, with the non-woven fabric sheet interposed therebetween; and

(vi) housing the electrode assembly and a non-aqueous electrolyte in a flexible housing and then hermetically sealing the housing under reduced pressure.

In electrospinning, nanofibers of the conjugated fiber are produced due to an electrostatic drawing phenomenon. Specifically, a starting solution with electric charge is discharged into a predetermined space for nanofiber formation; and the starting solution is drawn by the Coulomb repulsive force present in the starting solution. Once the repulsive force becomes greater than the surface tension of the starting solution, the starting solution is drawn explosively and linearly. Since the surface area of the drawn starting solution is significantly wider, large amounts of solvent evaporates from the starting solution. When the electric charge density in the starting solution becomes high due to such evaporation, the Coulomb repulsive force of the electric charge present in the starting solution becomes greater, and the starting solution becomes further drawn. Repetition of such process forms a conjugated fiber of the two or more kinds of macromolecules included in the starting solution.

According to an electrostatic drawing phenomenon, a fiber (nanofiber) having a fiber diameter of a size ranging from submicrons to the order of a nanometer can be produced efficiently. The fiber diameter of the produced conjugated fiber can be controlled by factors such as the state of the starting solution, the configuration of the discharger that discharges the starting solution, and the intensity of the electric field generated at the nanofiber formation space by a charging means.

Examples of the solvent in the starting solution including the first macromolecule and the second macromolecule include: acids (e.g., organic acid such as acetic acid; inorganic acid such as hydrochloric acid); bases (e.g., organic base such as triethylamine; inorganic base such as sodium hydroxide); and various organic solvents such as ketones (e.g., acetone), nitriles (e.g., acetonitrile), amides, ethers (e.g., tetrahydrofuran), sulfoxides (e.g., dimethyl sulfoxide), and N-methyl-2-pyrrolidone.

The fiber diameter of the conjugated fiber is preferably 50 to 2,000 nm. The conjugated fiber being a nanofiber with such fiber diameter allows higher porosity of the non-woven fabric sheet and retention of larger amounts of the non-aqueous electrolyte; and moreover, is favorable in improving charge and discharge characteristics due to smaller proportion of the active materials blocked by the conjugated fiber. The fiber diameter of the conjugated fiber is further preferably 60 to 1,500 nm and still further preferably 80 to 1,000 nm. Moreover, the fiber diameter of the conjugated fiber is preferably 800 nm or less. Here, fiber diameter is the maximum fiber diameter of the conjugated fiber when observed as a section.

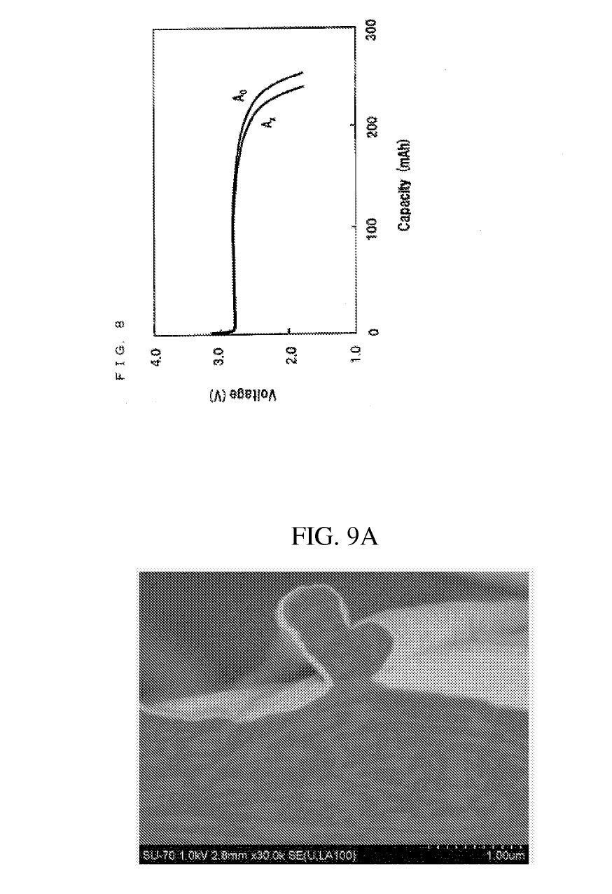

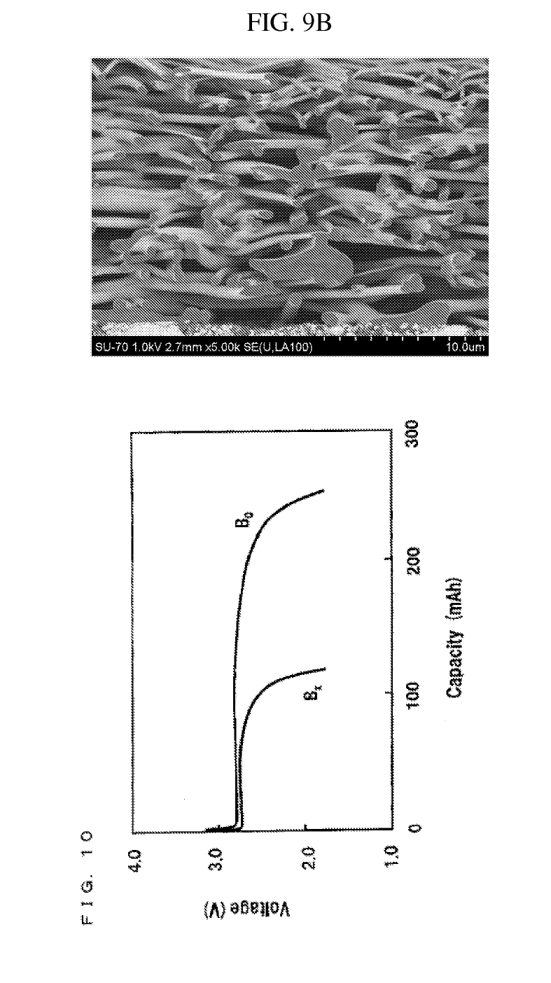

The non-woven fabric sheet is preferably formed mainly of the conjugated fiber with a fiber diameter of 50 to 2,000 nm. For example, when the non-woven fabric sheet is observed as a section running parallel to its thickness direction, in a 10 μm×10 μm area, 60% or more of the total area occupied by the conjugated fiber preferably has the conjugated fiber with a fiber diameter of 50 to 2,000 nm. As in FIG. 9B, the non-woven fabric sheet may also include the conjugated fiber having a fiber diameter less than 50 nm and greater than 2,000 nm.

The thickness of the electrolyte layer may be selected arbitrarily according to the thickness of the thin battery. The thickness of the electrolyte layer swollen with the non-aqueous electrolyte may be 5 to 200 μm for example. However, in view of reducing the thickness of the battery, the electrolyte layer is preferably thinner, and is preferably 10 to 100 μm and further preferably 15 to 70 μm.

In a preferred embodiment, the positive electrode includes: a positive electrode current collector; and a positive electrode material mixture layer that is attached to the positive electrode current collector and also is in contact with the electrolyte layer. Here, the positive electrode material mixture layer includes a positive electrode active material and a binder. When the conjugated fiber is deposited on a surface of such positive electrode by electrospinning, the non-woven fabric sheet and the positive electrode material mixture layer can be partially conjugated. As a result, at the interface between the electrolyte layer and the positive electrode material mixture layer, a composite layer including the conjugated fiber, the positive electrode active material, and the binder is formed. Presence of such composite layer allows the electrolyte layer and the positive electrode to adhere to each other more firmly.

In a preferred embodiment, the negative electrode includes a lithium metal sheet or a lithium alloy sheet (hereafter referred to as lithium-based active material). Such negative electrode includes, for example: a negative electrode current collector; and the lithium-based active material that is attached to the negative electrode current collector. Use of the lithium-based active material facilitates providing a high-capacity, low-cost thin battery.

As to the lithium-based active material, its volume varies greatly and its surface is relatively smooth; and therefore, its adhesive strength directed to the electrolyte layer usually tends to be low. However, due to forming the electrolyte layer with use of the non-woven fabric sheet including the conjugated fiber as above, such drawback is overcome with great improvement.

The housing is preferably formed of, for example, a laminate sheet including: a water vapor barrier layer; and a resin layer formed on both surfaces of the water vapor barrier layer. Since such housing prevents water vapor from entering the thin battery, degradation of the characteristics of the thin battery during storage is suppressed. Moreover, the laminate sheet has high flexibility and is therefore favorable in obtaining a thin battery with excellent resistance to degradation due to bending.

The structure of the electrode assembly is not particularly limited. In a preferred embodiment, the electrode assembly includes: a first electrode including a first current collector and a first active material layer attached to one surface of the first current collector; a second electrode including a second current collector and a second active material layer attached to one surface of the second current collector; and an electrolyte layer interposed between the first and second active material layers. The other surface of the first current collector and that of the second current collector sheet are each in contact with the inner surface of the housing. The first electrode including the first current collector and the first active material layer may be a positive electrode or a negative electrode.

In another preferred embodiment, the electrode assembly includes: a pair of first electrodes, each one including a first current collector and a first active material layer attached to one surface of the first current collector; a second electrode including a second current collector and second active material layers attached, respectively, to both surfaces of the second current collector; and an electrolyte layer interposed between the first active material layer and the second active material layer. The other surfaces of the first current collector sheets, respectively, are in contact with the inner surface of the housing. Here also, the first electrode including the first current collector and the first active material layer may be a positive electrode or a negative electrode.

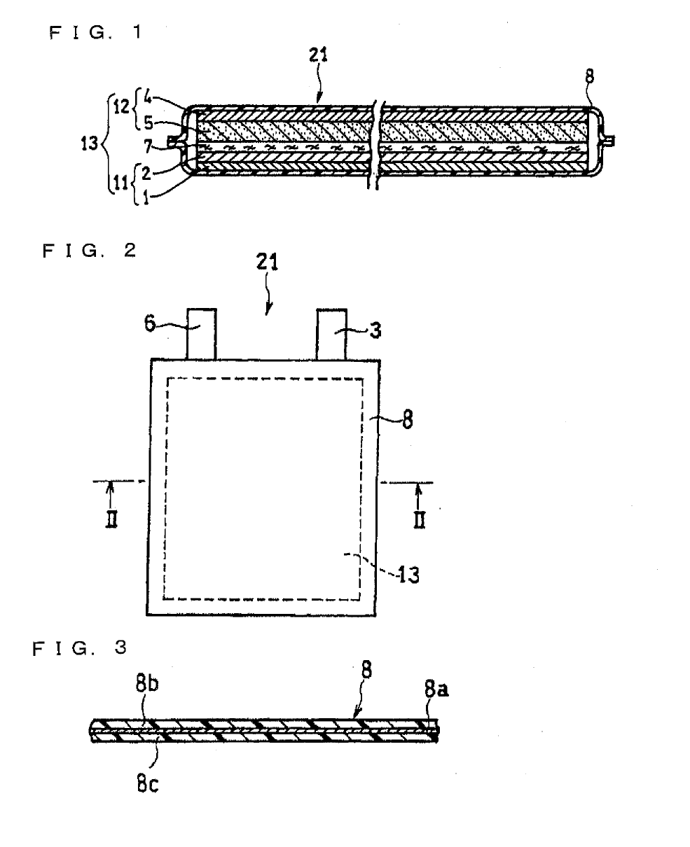

Next, a thin battery according to an embodiment of the present invention will be described with reference to FIGS. 1 and 2.

FIG. 1 is a schematic sectional view of a thin battery 21. FIG. 2 is a top view of the same. FIG. 1 corresponds to a sectional view of the same taken along the line II-II of FIG. 2. The battery 21 includes: an electrode assembly 13; and a housing 8 configured to house the electrode assembly 13. The electrode assembly 13 includes: a negative electrode 11; a positive electrode 12; and an electrolyte layer 7 interposed between the negative electrode 11 and the positive electrode 12. The negative electrode 11 has: a negative electrode current collector sheet 1; and a negative electrode active material layer 2 attached to one surface of the current collector sheet 1. The positive electrode 12 has: a positive electrode current collector sheet 4; and a positive electrode active material layer 5 attached to one surface of the current collector sheet 4. The negative electrode 11 and the positive electrode 12 are disposed such that the positive electrode active material layer 5 and the negative electrode active material layer 2 face each other, with the electrolyte layer 7 interposed therebetween. A negative electrode lead 3 is connected to the negative electrode current collector sheet 1; and a positive electrode lead 6 is connected to the positive electrode current collector sheet 4. The negative electrode lead 3 and the positive electrode lead 6 are both partially exposed to the outside by extending from the housing 8; and the exposed portions serve as a negative electrode external terminal and a positive electrode external terminal.

The housing 8 is formed of, for example, a laminate sheet including: a barrier layer; and a resin layer formed on both surfaces of the barrier layer. The method for forming the laminate sheet into a housing is not particularly limited. For example, when the laminate sheet has an area larger than the area of a rectangle corresponding to two assemblies of the electrode assembly 13 placed side by side along a planar surface, the laminate sheet is folded at the centerline, and two sides of peripheral edge portions connected via the centerline and facing each other are bonded, thereby to obtain a housing in pouch form. On the other hand, a housing in cylindrical form is obtained when the laminate sheet is folded at the centerline; and both end portions of the laminate sheet are made to overlap, and are then welded together.

For the negative electrode current collector sheet 1, a metal film or a metal foil is used. The current collector sheet 1 preferably does not form an alloy with the negative electrode active material and has excellent electron conductivity. Thus, the current collector sheet 1 is preferably a foil of at least one selected from the group consisting of: copper, nickel, titanium, and an alloy thereof; and stainless steel. The thickness of the current collector sheet 1 is preferably 5 to 30 μm for example. By the thickness of the current collector sheet 1 being 5 μm or more, the current collector sheet 1 can maintain excellent strength. By the thickness of the current collector sheet 1 being 30 μm or less, higher flexibility can be imparted to the current collector sheet 1 and occurrence of great stress to the current collector sheet 1 becomes less likely during bending.

The negative electrode active material layer 2 may be a lithium metal sheet or a lithium alloy sheet (lithium-based active material); a material mixture layer including a negative electrode active material in powder form, a binder, and as necessary, a conductive agent; or a deposited film formed by gas-phase deposition such as vapor deposition. Examples of the negative electrode active material in the material mixture layer include a carbon material (e.g., graphite), a silicon alloy, and a silicon oxide. Examples of the deposited film include a silicon alloy film and a silicon oxide film. The thickness of the negative electrode active material layer is preferably 1 to 300 μm further preferably 10 to 100 μm for example.

Examples of the lithium alloy include a Li—Si alloy, a Li—Sn alloy, a Li—Al alloy, a Li—Ga alloy, a Li—Mg alloy, and a Li—In alloy. In view of securing the negative electrode capacity, the proportion of an element other than Li present in the lithium alloy is preferably 0.1 to 10 wt %.

For the positive electrode current collector sheet 4, a metal material such as a metal film, a metal foil, or a non-woven fabric of metal fiber is used. The positive electrode current collector sheet is, for example, a foil of at least one selected from the group consisting of: silver, nickel, palladium, gold, platinum, aluminum, and an alloy thereof; and stainless steel. The thickness of the positive electrode current collector sheet is preferably 1 to 30 μm for example.

The positive electrode active material layer 5 may be a material mixture layer including a positive electrode active material, a binder, and as necessary, a conductive agent; or a deposited film formed by gas-phase deposition such as vapor deposition. The positive electrode active material is not particularly limited and can be, for example, at least one selected from the group consisting of manganese dioxide, fluorinated carbon (fluorinated graphite) a lithium-containing composite oxide, a metal sulfide, and an organic sulfur compound. The thickness of the positive electrode active material layer is preferably 1 to 300 μm for example.

A positive electrode active material suited for a primary battery is fluorinated graphite represented by (CF_{w})ₘ (where: m is an integer of 1 or higher; and 0<w≦1) , or manganese dioxide. A positive electrode active material suited for a secondary battery is a lithium-containing composite oxide such as LiₓₐCoO₂, LiₓₐNiO₂, LiₓₐMnO₂, LiₓₐCo_{y}Ni_{1-y}O₂, LiₓₐCO_{y}M_{1-y}O_{z}, LiₓₐNi_{1-y}M_{y}O_{z}, Li_{xb}Mn₂O₄, or Li_{xb}Mn_{2-y}M_{y}O₄. Here, M is at least one element selected from the group consisting of Na, Mg, Sc, Y, Mn, Fe, Co, Ni, Cu, Zn, Al, Cr, Pb, Sb, and B; xa=0 to 1.2; xb=0 to 2; y=0 to 0.9; and z=2 to 2.3. Also, xa and xb are values before starting charge and discharge that is to increase and decrease by charge and discharge.

Examples of the conductive agent that may be in the material mixture layer in the positive or negative electrode include: graphites such as natural graphite and artificial graphite; and carbon blacks such as acetylene black, Ketjen black, channel black, furnace black, lamp black, and thermal black.

Examples of the binder in the material mixture layer in the positive or negative electrode include: fluorocarbon resins such as polyvinylidene fluoride (PVDF) and polytetrafluoroethylene; acrylic resins such as polyacrylonitrile and polyacrylic acid; and rubber materials such as styrene-butadiene rubber.

The non-aqueous electrolyte is, for example, a mixture of a lithium salt and a non-aqueous solvent. Specific examples of the lithium salt include LiClO₄, LiBF₄, LiPF₆, LiCF₃SO₃, LiCF₃CO₂, and imide salts. Specific examples of the non-aqueous solvent include: cyclic carbonic acid esters such as propylene carbonate, ethylene carbonate, and butylene carbonate; chain carbonic acid esters such as diethyl carbonate, ethyl methyl carbonate, and dimethyl carbonate; and cyclic carboxylic acid esters such as γ-butyrolactone and γ-valerolactone.

The negative electrode lead 3 and the positive electrode lead 6 are connected to, for example, the negative electrode current collector sheet and the positive electrode current collector sheet, respectively, by welding. Preferred examples of the negative electrode lead include a copper lead, a copper alloy lead, and a nickel lead. Preferred examples of the positive electrode lead include a nickel lead and an aluminum lead.

Next, with reference to FIG. 3, a detailed explanation will be given of a laminate sheet including: a barrier layer; and a resin layer formed on both surfaces of the barrier layer, suited for use as the housing.

A laminate sheet 8 is a laminate including: an inorganic material layer (barrier layer) 8a; a first resin film 8b bonded to one surface of the barrier layer 8a; and a second resin film 8c bonded to the other surface of the barrier layer 8a.

The inorganic material used for forming the barrier layer 8a is not particularly limited; and a metal layer, a ceramic layer, or the like is preferably used in view of barrier performance, strength, and resistance to degradation due to bending. Specific preferred examples of the inorganic material include: metal materials such as aluminum, titanium, nickel, iron, platinum, gold, and silver; and inorganic oxide materials such as silicon oxide, magnesium oxide, and aluminum oxide. Among these, aluminum oxide and silicon oxide are particularly preferred due to allowing excellent balance between flexibility and barrier property of the resultant laminate sheet; and aluminum is particularly preferred due to low production cost.

In view of securing flexibility of the housing, the thickness of the barrier layer of the housing is preferably made as thin as possible, and is preferably 35 μm or less, further preferably 20 μm or less, and still further preferably 0.5 μm or less, for example. However, in view of securing barrier property for the duration of use of the thin battery or the battery device, the thickness of the barrier layer is preferably 0.01 μm or more, further preferably 0.05 μm or more, and still further preferably 0.1 μm or more.

In view of ease of thermal welding, electrolyte resistance, and chemical resistance, the material of the resin film disposed on the inner surface side of the housing is preferably a polyolefin such as polyethylene (PE) or polypropylene (PP); or polyethylene terephthalate, polyamide, polyurethane, or polyethylene-vinyl acetate (EVA), for example. In a similar view, the thickness of the resin film on the inner surface side is preferably 10 to 100 μm and further preferably 10 to 50 μm

In view of strength, impact resistance, and chemical resistance, the resin film disposed on the outer surface side of the housing is preferably a polyamide (PA) such as 6,6-nylon; a polyolefin; or a polyester such as polyethylene terephthalate (PET) or polybutylene terephthalate, for example. In a similar view, the thickness of the resin film on the outer surface side is preferably 5 to 100 μm and further preferably 10 to 50 μm.

The total thickness of the laminate sheet is 15 to 300 μm and preferably 30 to 150 μm, for example. When the total thickness of the laminate sheet is in the above range, the various qualities required of the housing can be sufficiently secured, and the thin battery and its packaging can be easily kept thin.

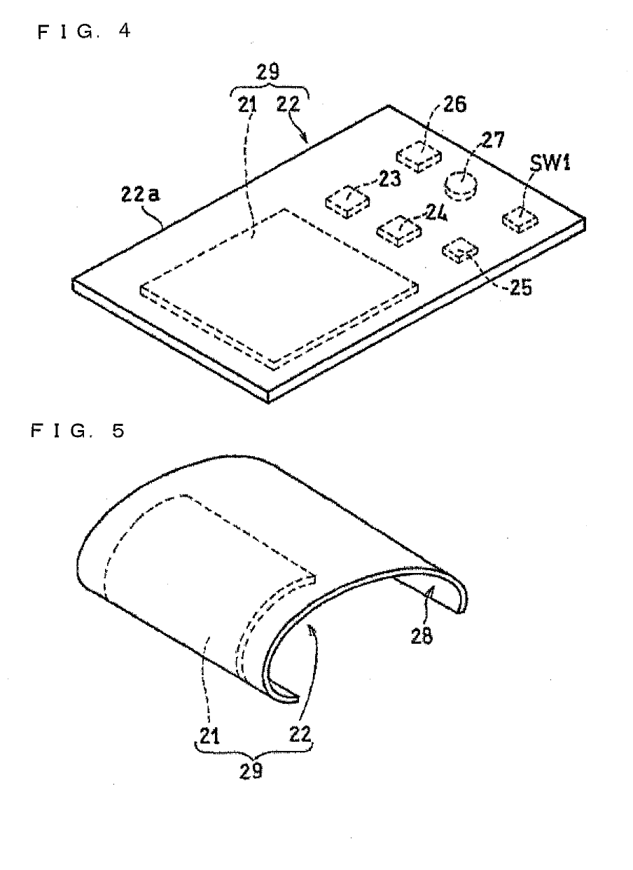

Next, a description will be given of an example of a device having a thin battery loaded therein, with reference to FIG. 4.

A thin battery is suited for producing a device in the form of one sheet including a thin battery and an electronic device that are integrated together. Examples of such electronic device include biological wearable devices such as a biological information measuring device and an iontophoretic dermal administration device.

A biological wearable device is used in contact with a living body, and therefore requires flexibility to the extent that the user feels no discomfort even when the device is close to its skin for a long period of time. Thus, the driving power source for the biological wearable device also requires excellent flexibility. A thin battery is useful as a power source for such device.

FIG. 4 is an oblique view of an example of a battery-electronic device assembly (battery device) including a biological information measuring device. FIG. 5 is an illustration of an example of the appearance of the device when deformed.

A biological information measuring device 22 includes a holding member 22a in sheet form configured to hold the components of the device 22. The holding member 22a is made of a flexible material; and a temperature sensor 23, a pressure-sensitive element 24, a memory 25, an information transmitter 26, a button switch SW1, and a controller 27 are embedded therein, occupying the space extending from the inside to the surface of the holding member 22a. The thin battery 21 occupies a flat space provided inside the holding member 22a. That is, the battery 21 and the biological information measuring device 22 are integrated together as one sheet, to produce a battery-electronic device assembly 29.

For the holding member 22a, an electrically insulated resin material can be used, for example. By applying an adhesive 28 having adhesive strength, for example, to one main surface of the battery-electronic device assembly, the biological information measuring device 22 becomes capable of being strapped around the wrist, ankle, neck, and other parts of the user.

The temperature sensor 23 includes, for example, a heat-sensitive element such as a thermistor or a thermocouple; and outputs signals indicating body temperature of the user, to the controller 27. The pressure-sensitive element 24 outputs signals indicating blood pressure and pulse of the user, to the controller 27. For the memory 25 which stores information corresponding to the signals that have been output, a nonvolatile memory can be used, for example. The information transmitter 26 converts necessary information into radio waves according to the signals from the controller 27, and then radiates the radio waves. The switch SW1 is used for turning on or off the biological information measuring device 22.

Next, an example of a production method of a thin battery will be described.

### (a) Production of Positive Electrode

A positive electrode is obtained, for example, by mixing a positive electrode material mixture including a positive electrode active material, a conductive agent, and a binder, together with a dispersion medium such as N-methyl-2-pyrrolidone (NNP), to prepare a positive electrode material mixture paste; applying the paste to a positive electrode current collector sheet, followed by drying; and then pressing the resultant.

### (b) Production of Negative Electrode

A negative electrode is obtained, for example, by pressure bonding a lithium metal sheet or a lithium alloy sheet to a negative electrode current collector sheet, so that the lithium metal or alloy sheet and the current collector sheet are brought into contact with each other.

### (c) Production of Non-Woven Fabric Sheet

A non-woven fabric sheet includes: producing a conjugated fiber including a first macromolecule without a cross-linked structure and a second macromolecule with a cross-linked structure by electrospinning, from a starting solution including the first macromolecule and the second macromolecule; and forming a non-woven fabric sheet including the conjugated fiber, by deposition of the produced conjugated fiber on a surface of the electrode.

In the producing step of the conjugated fiber, the starting solution including a solvent and the first macromolecule and the second macromolecule dissolved in the solvent, is discharged into a predetermined space for nanofiber formation. The discharged starting solution is drawn due to an electrostatic drawing phenomenon and becomes a conjugated fiber.

The forming step of the non-woven fabric sheet is conducted subsequent to the producing step of the conjugated fiber, at the end position of the nanofiber formation space (i.e., electrode surface). The conjugated fiber is deposited on the electrode surface immediately after its production, to form a non-woven fabric sheet.

### (d) Production of Electrode Assembly

Next, the positive electrode and the negative electrode are laminated together with the non-woven fabric sheet interposed therebetween, to form an electrode assembly. Since the non-woven fabric sheet is formed to have uniform thickness on a surface of at least one of the positive electrode and the negative electrode, the positive electrode and the negative electrode are arranged such that the positive electrode active material layer and the negative negative electrode active material layer face each other, thereby allowing formation of an electrode assembly not including a non-aqueous electrolyte. Note that a negative electrode lead and a positive electrode lead are attached to the negative electrode and the positive electrode, respectively, before production of the electrode assembly.

### (e) Assembling of Battery

Next, the electrode assembly is put into a housing, together with the non-aqueous electrolyte; and the housing is hermetically sealed under reduced pressure, thereby to complete a thin battery. Specifically, the electrode assembly is inserted into one opening of, for example, a housing in cylindrical form; and then the opening is closed by thermal welding. At that time, the electrode assembly is arranged such that the positive electrode lead and the negative electrode lead are both partially exposed to the outside by extending from the one opening of the cylindrical housing. The exposed portions become a positive electrode external terminal and a negative electrode external terminal. Then, after the non-aqueous electrolyte is injected into the cylindrical housing from the other opening, that other opening is closed by thermal welding under reduced pressure. In such manner, the electrode assembly is hermetically sealed in the housing. The gaps in the electrode assembly, mainly the gaps in the non-woven fabric sheet, are filled with the non-aqueous electrolyte, thereby causing the conjugated fiber to swell with the non-aqueous electrolyte and form an electrolyte layer.

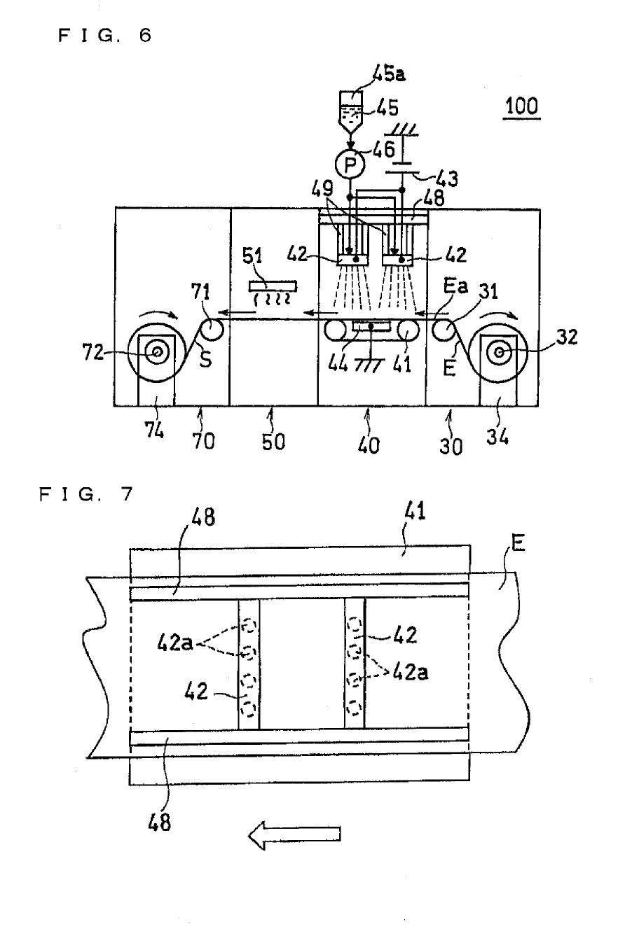

Next, with reference to FIG. 6, a description will be given of an example of a production system for producing a non-woven fabric sheet.

A production system 100 in FIG. 6 is configured to have a production line for forming a non-woven fabric sheet by directly depositing a conjugated fiber on an electrode surface. In the production system 100, an electrode E with an elongated shape is conveyed from upstream to downstream of the production line. The production system 100 is used when continuously forming a non-woven fabric sheet on a surface of the electrode E with an elongated shape; and the configuration of the production system is modified as appropriate according to electrode shape.

Provided on the most upstream side of the production system 100, is an electrode feeding machine 30 which houses the electrode E wound in roll form. The electrode feeding machine 30 reels out the rolled electrode E and feeds it to another machine adjacently arranged on the downstream side. Specifically, the electrode feeding machine 30 causes a feeding reel 32 to rotate by a motor 34 and feeds the electrode E wound on the feeding reel 32 to a first conveying roller 31.

The electrode E reeled out is moved to a non-woven fabric sheet forming machine 40 by the first conveying roller 31. The non-woven fabric sheet forming machine 40 includes an electrospinning mechanism. More specifically, an electrospinning mechanism usually includes: a discharger 42 configured to discharge a starting solution set at the upper part of the machine; a charging means configured to charge the discharged starting solution; and a collector. Here, a conveyor 41 configured to convey the electrode E from upstream to downstream, with the electrode E facing the discharger 42, functions as the collector in collaboration with the electrode E to collect the conjugated fiber.

The charging means include: a voltage applying device 43 configured to apply voltage to the discharger 42; and a counter electrode 44 set in parallel with the conveyor 41 and electrically connected to the conveyor 41. The counter electrode 44 is grounded. By such grounding, a potential difference (e.g., 20 to 200 kV) corresponding to the voltage applied by the voltage applying device 43 can be provided between the discharger 42 and the counter electrode 44. Note that the configuration of the charging means is not particularly limited. For example, the counter electrode 44 is not necessarily grounded and high voltage may be applied thereto. Moreover, as an alternative to providing the counter electrode 44, a belt part of the conveyor 41 maybe formed from a conductive matter, for example.

The discharger 42 is formed of a conductive matter, has an elongated shape, and is hollow inside. The hollow portion serve as a container for containing a starting solution 45. On the side of the discharger 42 facing the electrode E, discharge outlets are provided at fixed intervals in a regular arrangement. The starting solution 45 is supplied from a starting solution tank 45a into the hollow of the discharger 42 by pressure produced by a pump 46 which communicate with the hollow portion of the discharger 42. Then, the starting solution 45 is discharged from the discharge outlets toward a surface Ea of the electrode E. The discharged starting solution cause an electrostatic burst while being charged and moving in a space between the discharger 42 and the conveyor 41, thereby producing a conjugated fiber. The produced conjugated fiber is attracted to the surface Ea of the electrode E by an electrostatic attractive force, and is deposited thereon. Thus, a non-woven fabric sheet is formed such that it is attached to the electrode surface.

FIG. 7 is a schematic top view of the configuration of the non-woven fabric sheet forming machine 40. In the non-woven fabric sheet forming machine 40, the discharger 42 is set to be perpendicular to the direction (direction of the outlined arrow in FIG. 7) in which the electrode E is conveyed. The discharger 42 is supported by a second support 49 that extend downward from a first support 48 set at the upper part of the non-woven fabric sheet forming machine 40 and in parallel with the direction in which the electrode E is conveyed, such that the lengthwise direction of the discharger 42 is in parallel with the surface Ea of the electrode.

On the side of the discharger 42 facing the surface Ea of the electrode E, a plurality of discharge outlets 42a for the starting solution are provided. By having the discharge outlets 42a arranged in a regular pattern on the discharger 42, the amount of the conjugated fiber deposited on the surface Ea of the electrode E can be made uniform over a wide area of the surface Ea. The distance between the discharge outlets 42a on the discharger 42 and the surface Ea of the electrode E depends on the size of the production system, and may be 100 to 600 mm for example.

The non-woven fabric sheet-electrode assembly conveyed from the non-woven fabric sheet forming machine 40 is conveyed to a drying machine 50 arranged further downstream. Provided in the drying machine 50 is a temperature/humidity adjusting device 51. In the drying machine 50, when the active material or other substances in the electrode E near the surface of the electrode E diffuses into the non-woven fabric sheet during drying of the sheet, the non-woven fabric sheet and the material mixture layer are able to be partially conjugated. As a result, a composite layer including the conjugated fiber, the active material, and the binder is formed at the interface between the electrolyte layer and the material mixture layer. Presence of such composite layer allows firmer adhesion between the electrolyte layer and the electrode.

A completed non-woven fabric sheet-electrode assembly S is conveyed from the drying machine 50 to a collector 70; and is reeled in by a collecting reel 72 via a second conveying roller 71. The collecting reel 72 is rotationally driven by a motor 74.

Next, the thin battery of the present invention will be described in more detail, with reference to Examples.

### EXAMPLE 1

By the following procedures, a thin battery having a basic structure similar to the one of a battery illustrated in FIGS. 1 and 2, was produced.

### (1) Production of Negative Electrode

For a negative electrode current collector sheet 1, a 12 μm-thick electrolytic copper foil was prepared. On one surface of the electrolytic copper foil, a lithium metal sheet (thickness: 20 μm) serving as a negative electrode active material layer 2 was pressure bonded under a linear pressure of 100 N/cm, to obtain a negative electrode 11. This was cut such that the resultant was 50 mm×50 mm in size and had a 5 mm×5 mm tab portion in the middle of one short side. Then, a negative electrode lead 3 of copper was ultrasonically welded to the tab portion.

### (2) Production of Positive Electrode

Electrolytic manganese dioxide heated at 350° C. as a positive electrode active material, acetylene black as a conductive agent, and a solution of N-methyl-2-pyrrolidone (NMP) containing polyvinylidene fluoride (PVDF) as a binder were mixed such that the weight ratio of the manganese dioxide to the acetylene black to the PVDF would be 100:5:5. Then, a moderate amount of NMP was added to the resultant, to obtain a positive electrode material mixture paste.

For a positive electrode current collector sheet 4, an aluminum foil (thickness: 15 μm) was prepared. The positive electrode material mixture paste was applied to one surface of the aluminum foil, followed by drying at 85° C. for 10 minutes, to form a positive electrode material mixture layer 5. The resultant was compressed under a linear pressure of 12,000 N/cm using a roll press machine, to obtain a positive electrode 12. This was cut such that the resultant was 50 mm×50 mm in size and had a 5 mm×5 mm tab portion in the middle of one short side, and then dried under reduced pressure at 120° C. for 2 hours. Then, a positive electrode lead 6 of aluminum was ultrasonically welded to the tab portion.

### (3) Production of Non-Woven Fabric Sheet-Positive Electrode Assembly

### Preparation of Starting Solution

A solution including: 5 mass % of a vinylidene fluoride-hexafluoropropylene copolymer (content of vinylidene fluoride units: 95 mol %, weight-average molecular weight: 600,000) as a first macromolecule; 5 mass % of a polymer (weight-average molecular weight: 1,000,000) having a core-shell structure as a second macromolecule; and dimethylacetamide as a solvent, was prepared. The content of the first macromolecule relative to the total of the first and second macromolecules dissolved in the starting solution was 50 mass %.

For the polymer having a core-shell structure, a polymer in which: the core part contained a polystyrene structure; the shell part contained a polyethylene oxide structure; the content of the polyethylene oxide structure was 40 mass %; and a cross-linked structure was formed, was used. Here, the shell parts of the core-shell polymers adjacent to one another were linked using a cross-linking agent (tolylene diisocyanate).

### (Electrospinning)

The starting solution was discharged from a discharger included in a machine having an electrospinning mechanism, as illustrated in FIGS. 6 and 7, thereby to form a conjugated fiber including a first macromolecule and a second macromolecule and depositing the conjugated fiber on a surface of the positive electrode material mixture layer in the positive electrode positioned below the discharger. Here, the distance between the discharger and the positive electrode was 300 mm; the electric field in the electrospinning mechanism was adjusted such that the conjugated fiber was produced to have an average fiber diameter of 650 nm; and the conjugated fiber was deposited until a 35 μm-thick non-woven fabric sheet of the conjugated fiber was formed on the surface of the positive electrode material mixture layer.

### (4) Production of Electrode Assembly

The negative electrode and the positive electrode were laminated together, such that the lithium metal sheet and the positive electrode material mixture layer faced each other with the non-woven fabric sheet interposed therebetween. Then, the resultant was hot pressed at 90° C. in the laminated direction, under a pressure of 1 MPa, to form an electrode assembly 13.

### (5) Assembling of Battery

The electrode assembly was placed in a housing (thickness: 70 μm) being a laminate film in tube form with a barrier layer of aluminum. At that time, the positive electrode lead and the negative electrode lead were partially exposed to the outside by extending from one opening of the housing. Then, the opening thereof was closed by thermal welding, with the positive electrode lead and the negative electrode lead 3 nipped by the closed portion. Then, after injecting 0.8 g of a non-aqueous electrolyte into the housing via its other opening, the resultant was degassed for 10 seconds in an environment of reduced pressure of 660 mmHg.

For the non-aqueous electrolyte, a non-aqueous solvent with LiClO₄ dissolved therein at a concentration of 1 mol/L was used. For the non-aqueous solvent, a mixed solvent (volume ratio: 1:1) of propylene carbonate and dimethoxyethane was used.

Then, the other opening of the housing was closed by thermal welding to hermetically seal the housing with the electrode assembly therein. In this manner, a 60 mm×65 mm thin battery was completed. The obtained battery was aged at 45° C. for 1 day. Then, the aged battery was discharged at a current density of 250 μA/cm² in an environment at 25° C. until the closed circuit voltage reached 3 V.

### [Evaluation]

The battery, with its closed circuit voltage set to 3 V, was discharged at a current density of 250 μA/cm² in an environment at 25° C. until the closed circuit voltage became 1.8 V, to obtain a discharge capacity (X₀). The discharge curve at that time is indicated as a curve A₀ in FIG. 8.

Another one of the battery, with its closed circuit voltage set to 3 V, was prepared; and its thermally-welded, closed portions at both ends were fixed using expandable fixing members that were horizontally positioned to face the closed portions, respectively. Then, a jig having a curved surface portion with a 20 mm radius of curvature was pressed onto the center of the battery, to make the battery bend and deform following the curved surface portion. After 30 seconds, the jig was separated from the battery, and the battery regained its original form. This bending deformation was repeated 10,000 times.

Then, the battery that had undergone the bending deformation treatment was discharged at a current density of 250 μA/cm² in an environment at 25° C. until the closed circuit voltage became 1.8 V, to obtain a discharge capacity (X). The discharge curve at that time is indicated as a curve Ax in FIG. 8. Furthermore, the proportion of the capacity X relative to the capacity X₀ was obtained in percentage, as the capacity retention rate. The results are shown in Table 1.

TABLE 1

| | Capacity retention rate (%) |
|---|---|
| Ex. 1 | 96 |
| Comp. Ex. 1 | 47 |
| Comp. Ex. 2 | 51 |

Next, the section of the conjugated fiber forming the non-woven fabric sheet, taken perpendicular to its lengthwise direction, was observed using a scanning electron microscope (FIGS. 9A and 9B). As a result, it was observed that the section had a matrix-domain structure as in FIG. 9A.

### COMPARATIVE EXAMPLE 1

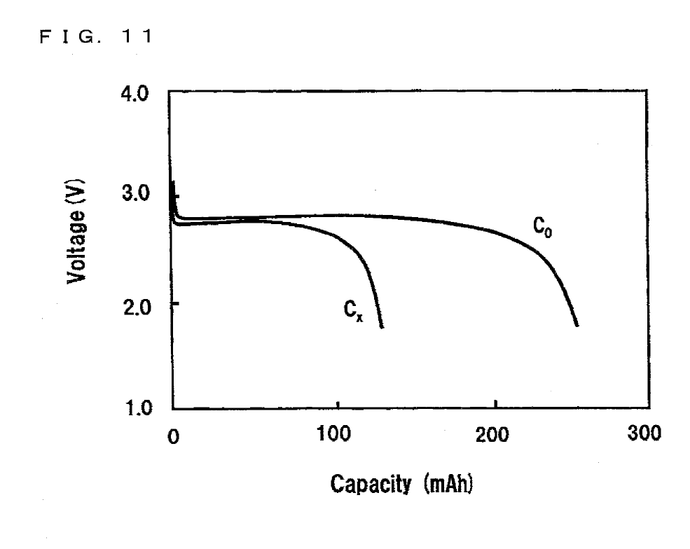

The second macromolecule was not used as the starting material for the non-woven fabric sheet. Specifically, except for use of a solution containing: 10 mass % of only the first macromolecule being vinylidene fluoride-hexafluoropropylene copolymer, i.e., the same as the one used in Example 1; and dimethylacetamide as a solvent, as the starting solution for the non-woven fabric sheet, a thin battery was produced and evaluated as in Example 1. Discharge curves for the battery before and after the bending deformation treatment are indicated as curves B₀ and Bₓ, respectively, in FIG. 10. Capacity retention rate is shown in Table 1.

### COMPARATIVE EXAMPLE 2

Except for use of a polymer (weight-average molecular weight: 200,000) having a core-shell structure and not a cross-linked structure, as the second macromolecule, a thin battery was produced and evaluated as in Example 1. As the polymer having a core-shell structure, a polymer in which the core part contained a polystyrene structure, the shell part contained a polyethylene oxide structure, and the content of the polyethylene oxide structure was 40 mass %, was used as in Example 1. Discharge curves for the battery before and after the bending deformation treatment are indicated as curves C₀ and Cₓ, respectively, in FIG. 11. Capacity retention rate is shown in Table 1.

### EXAMPLES 2 TO 5

Except for changing the content of the first macromolecule relative to the total of the first and second macromolecules dissolved in the starting solution, to 10 mass %, 30 mass %, 60 mass %, and 70 mass %, thin batteries were produced and evaluated, respectively, as in Example 1. Capacity retention rates are shown in Table 2.

TABLE 2

| | Content of first macromolecule | Capacity retention |
|---|---|---|
| | (%) | rate (%) |
| Ex. 2 | 10 | 86 |
| Ex. 3 | 30 | 94 |
| Ex. 4 | 60 | 83 |
| Ex. 5 | 70 | 81 |

The foregoing results show that a high capacity retention rate is obtained when the content of the first macromolecule relative to the total of the first and second macromolecules is 10 to 70 mass %. It is also evident that the content of the first macromolecule is preferably 30 to 50 mass %.

### INDUSTRIAL APPLICABILITY

The thin battery of the present invention has excellent resistance to degradation due to bending, and is therefore useful as a power source for a device used in contact with a living body and thus requiring flexibility, for example.

### EXPLANATION OF REFERENCE NUMERALS

1 negative electrode current collector sheet

2 negative electrode active material layer

3 negative electrode lead

4 positive electrode current collector sheet

5 positive electrode active material layer

6 positive electrode lead

7 electrolyte layer

8 housing

8a barrier layer

8b, 8c resin layer

11 negative electrode

12 positive electrode

13 electrode assembly

21 thin battery

22 biological information measuring device

22a holding member

23 temperature sensor

24 pressure-sensitive element

25 memory

26 information transmitter

27 controller

28 adhesive

29 battery-electronic device assembly

30 electrode feeding machine

31 first conveying roller

32 feeding reel

34 motor

40 non-woven fabric sheet forming machine

41 conveyor

42 discharger

42a discharge outlet

43 voltage applying device

44 counter electrode

45 starting solution

45a tank

46 pump

48 first support

49 second support

50 drying machine

51 temperature/humidity adjusting device

70 collecting machine

71 second conveying roller

72 collecting reel

74 motor

100 production system

1. A thin battery comprising:
an electrode assembly; and
a flexible housing configured to house the electrode assembly,
the electrode assembly including:
a positive electrode in sheet form;
a negative electrode in sheet form; and
an electrolyte layer interposed between the positive electrode and the negative electrode,
the electrolyte layer including:
a non-aqueous electrolyte; and
a non-woven fabric sheet configured to retain the non-aqueous electrolyte,
the non-woven fabric sheet comprising a conjugated fiber including at least two kinds of macromolecules conjugated together, and
the at least two kinds of macromolecules including:
a first macromolecule without a cross-linked structure; and
a second macromolecule with a cross-linked structure.

2. The thin battery in accordance with claim 1,
wherein a section of the conjugated fiber has a matrix-domain structure including: a matrix element; and a domain element dispersed in the matrix element,
the domain element comprises the first macromolecule, and
the matrix element comprises the second macromolecule.

3. The thin battery in accordance with claim 1, wherein a content of the first macromolecule in the conjugated fiber is 10 to 70 mass %.

4. The thin battery in accordance with claim 1, wherein the first macromolecule is a polymer having vinylidene fluoride units.

5. The thin battery in accordance with claim 1, wherein the second macromolecule is a polymer having at least one selected from the group consisting of acrylic ester units and methacrylic ester units.

6. The thin battery in accordance with claim 1, wherein the second macromolecule is a polymer having a core-shell structure with a core part and a shell part.

7. The thin battery in accordance with claim 6, wherein the shell part has at least a polyalkylene oxide structure.

8. The thin battery in accordance with claim 1, wherein the non-woven fabric sheet is formed by producing the conjugated fiber from a starting solution including the first macromolecule and the second macromolecule by electrospinning, and depositing the produced conjugated fiber on a surface of at least one of the positive electrode and the negative electrode.

9. A production method of a thin battery, the method comprising
(i) preparing a positive electrode in sheet form;
(ii) preparing a negative electrode in sheet form;
(iii) producing a conjugated fiber including a first macromolecule without a cross-linked structure and a second macromolecule with a cross-linked structure by electrospinning, from a starting solution including at least the first macromolecule and the second macromolecule;
(iv) forming a non-woven fabric sheet including the conjugated fiber, by depositing the produced conjugated fiber on a surface of at least one of the positive electrode and the negative electrode;
(v) forming an electrode assembly by lamination of the positive electrode and the negative electrode, with the non-woven fabric sheet interposed therebetween; and
(vi) housing the electrode assembly and a non-aqueous electrolyte in a flexible housing and then hermetically sealing the housing under reduced pressure.
